(19) United States
(12) Patent Application Publication
(10) Pub. No.: US 2011/0120970 A1
(43) Pub. Date: May 26, 2011

(54) NANOPOROUS ANTIREFLECTION THIN FILM AND METHOD OF PRODUCING THE SAME USING BLOCK COPOLYMERS

(75) Inventors: Won Chul Joo, Gyungsangbuk-do (KR); Jin Kon Kim, Gyungsangbuk-do (KR); Min Soo Park, Chungcheongbuk-do (KR)

(73) Assignee: Postech Academy-Industry Foundation, Gyungsangbuk-do (KR)

(21) Appl. No.: 11/947,857

(22) Filed: Nov. 30, 2007

(30) Foreign Application Priority Data
Nov. 30, 2006 (KR) 10-2006-0119605

(51) Int. Cl. B29D 11/00

(52) U.S. Cl. 216/24; 216/56

(57) ABSTRACT

Disclosed herein is a method of producing an antireflection thin film using a block copolymer and an antireflection thin film prepared by the method. Specifically, the present invention relates to a method of producing a nanoporous antireflection film by spin-coating using a block copolymer solution and subsequent processing and a preparation by the method. The antireflection film of the present invention is prepared by coating a substrate with a block copolymer and selectively removing at least one block in the coated block copolymer to produce a nanoporous thin film with a pore size of 5 to 100 nm. When the thin film is applied to a substrate, an antireflection substrate which has a very low reflectance within a broad range of wavelength can be prepared.

### BACKGROUND OF THE INVENTION

1. Field of the Invention

The present invention relates to a method of producing an antireflection thin film using a block copolymer and an antireflection thin film prepared by the method. Specifically, the present invention relates to a method of producing a nanoporous antireflection thin film having a superior antireflection effect by spin-coating using a block copolymer solution and subsequent processing and a nanoporous antireflection thin film prepared by the method.

2. Background of the Related Art

Antireflection coating film refers to a film used for preventing a reflection of light on a transparent substrate. Such films are used in various display devices such as LCD, PDP flat display, flexible polymer film, etc. In the above devices, the film is mounted on a given position apart from a surface of the display device in order to improve a quality of image. The film is an essential component of optical filter together with a selective absorption layer to enhance color tone and an electromagnetic shielding layer. For example, in case where the film is applied to a flat display, more clear image quality can be provided with the same powder supply and, also, a prevention of eye from glare can be obtained due to a destructive interference of light occurred on the surface of film.

FIGS. 1a and 1b are a perspective view and a cross-sectional view of the optical filter commonly used in a PDP display, respectively. Referring to the drawings, filter (100) and PDP (110) are arranged several nm apart from each other, wherein the filter (100) comprises a glass or transparent plastic substrate (103) as a transparent substrate for attaching each film thereto, has a structure laminated with a electromagnetic shielding layer (104), a selective absorption layer for the enhancement of color tone (102), an antireflection layer (101), etc., and grounds an electric charge in the conductive film through a chassis (120) inside the PDP.

As for the above filters, Korean Patent Laid-Open Publication No. 2004-7002099 and Japanese Patent Laid-Open Publication Nos. 2001-137282 and 1999-091091 disclose optical filters using dyes which absorb a light of specific wavelength.

Up to now, vapor deposition of minerals or coating with a double-layered structure consisted of a low refractive layer of fluorinated polymer and a high refractive layer of acrylic polymer have been used for the preparation of such antireflection films. Introducing nanopores showing a low light scattering into the films had been tried to produce a low refraction layer.

However, the methods according to the conventional techniques have disadvantages in that the methods comprise multi-steps which make the process complex and need to use high cost apparatus such as a vapor deposition system using high vacuum and the like and that the fluorinated polymers used for the method are expensive and also have a difficulty in handling them.

### SUMMARY OF THE INVENTION

An object of the present invention is to provide a method of producing a porous thin film using a block copolymer.

Another object of the present invention is to provide a method of producing a porous antireflection thin film using a block copolymer.

Yet another object of the present invention is to provide a porous thin film using a block copolymer.

Further object of the present invention is to provide an antireflection thin film coated with a porous thin film using a block copolymer.

Still further object of the present invention is to provide a substrate coated with an antireflection thin film using a block copolymer.

### BRIEF DESCRIPTION OF THE DRAWINGS

FIGS. 1a and 1b schematically show the perspective and the cross-sectional views of the optical filter which is generally used in display devices.

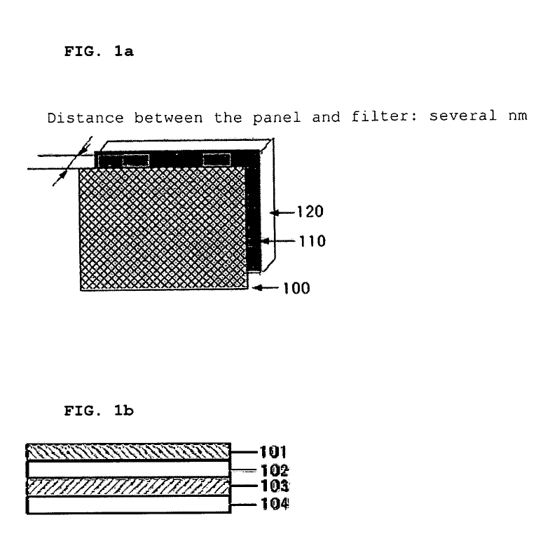

FIG. 2 is a graph showing the reflectance (%) of glass coated with the antireflection film according to the present invention with a variation of film thickness.

FIG. 3 is a cross-sectional SEM (scanning electron microscopy) image of the antireflection film prepared according to the present invention.

### DETAILED DESCRIPTION OF THE PREFERRED EMBODIMENT

To accomplish said objects of the present invention, the inventive method comprises the steps of coating a substrate with a block copolymer and removing at least one block to produce a nanoporous thin film.

The present invention uses the self-assembling property which occurs by chemical bonding of different polymer chains and the microphase separation in a nano-scale of the block copolymer. Thus, so long as the block copolymer has said features, any kinds and types of block copolymers can be used and they can be prepared by a conventional block copolymerization.

In one embodiment of the present invention, the block copolymer can be selected from acrylate-based block copolymer such as polystyrene-block-poly(methylmethacrylate), polyvinylpyridine-block-poly(methylmethacrylate) an the like, polystyrene-block-polyvinylpyridine, polystyrene-block-polyisoprene, polystyrene-block-polybutadiene and polystyrene-block-polyethylene oxide, and linear- or graft-type block copolymers can be used.

The block copolymer can be coated on a substrate by various coating processes, preferably in order to induce a phase separation which allows the same kinds of polymer chains to get together, the copolymer is first dissolved in a solvent and the solution is coated on the substrate. In one embodiment of the present invention, the block copolymer solution is coated on the substrate by a spin-coating method, a bar-coating process or a roll-coating process and the spin-coating method to rapidly evaporate the solvent is preferred.

Specific block components in the block copolymer can be selectively removed. The removing method is not specifically limited so long as the method can selectively remove specific block components. In a preferred embodiment, an ozone treatment, an ultraviolet treatment or a chemical treatment can be selected.

Without being bound to any specific theory, it is believed that the same kinds of polymer chains which become together by a phase separation and the like are selectively removed by said treatment and thus nanopores which can effectively prevent light scattering at a infrared range are formed. In one embodiment of the present invention, the pore size which is formed by the selective removal of block copolymer is 5 to 100 nm.

In one aspect of the present invention, the present invention provides a method of producing a nanoporous thin film for antireflection which comprises the steps of coating a substrate with a block copolymer and selectively removing at least one block in the coated block copolymer.

In the inventive method, the film is recognized as a low refraction layer due to a pore generated at various wavelengths and the destructive interference which is attributed to the path difference of reflection on the surfaces of the film and the substrate makes the nanoporous film antireflective.

The substrate on which the block copolymer is coated is preferably a substrate which has a refraction index for a destructive interference of light. More preferably, the substrate has a refraction index of 1.45 to 1.8. If the index is out of said range, the result of destructive interference is not high, which makes the antireflection effect reduced and thus not preferred.

The substrate can have various intensities and materials and include, for example, a glass, indium tin oxide (ITO) and plastics of polyesters (PET), imide, polycarbonate, etc. In the embodiment of the present invention, it is preferred to use a substrate which is not dissolved in the block copolymer solution.

The block copolymer can be used in a solution phase. A use of the block copolymer of which one component can be selectively degraded and removed by an ozone (O₃) treatment, a ultraviolet irradiation, a chemical treatment and the like is preferred to coat the substrate. In one embodiment of the present invention, the block copolymer coated in a liquid phase involves a microphase separation in a short-range scale wherein the same kinds of polymer chains become together, with a rapid evaporation of the solvent. Since this phenomenon occurs within several tens nm, when one component in the block copolymer is removed, nanoporous pores are generated, resulting in preventing the light scattering within a range of infrared wavelength.

The block copolymer which can be used for the present invention includes, but is not limited to, acrylate-based block copolymer such as polystyrene-block-poly(methylmethacrylate), polyvinylpyridine-block-poly(methylmethacrylate) an the like, polystyrene-block-polyvinylpyridine, polystyrene-block-polyisoprene, polystyrene-block-polybutadiene and polystyrene-block-polyethylene oxide.

The solvent used for the preparation of the block copolymer solution includes many organic solvents such as toluene, tetrahydrofuran, benzene, etc. Any kinds of solvents can be used in the inventive method, if the solvents can dissolve the block copolymer with a provision of even thickness of the coating.

After coating the substrate with the block copolymer, one component in the block copolymer is removed, resulting in generating a nanoporous film. The method of removing one component can vary according to the nature of decomposition. In one embodiment of the present invention, polystyrene-block-polyacrylate block copolymer can be exposed to an infrared wavelength in a vacuum, polystyrene-block-polyisoprene or butadiene block copolymer can be exposed to an ozone, polystyrene-block-polyethylene oxide block copolymer can be chemically treated with an acid.

The methods to remove the degraded components are not limited to specific ones, if they can remove only the degraded components without affecting the remained polymer chains. In one embodiment of the present invention, after exposing the polystyrene-block-polyacrylate block copolymer to infrared wavelength in a vacuum, the selective removal can be performed by rinsing the film with a solvent degrading only the acrylate component.

The formed pore volume corresponds to that of the block removed from the film. The volume removed can be controlled so as to achieve the antireflective effect. Preferably, the volume fraction removed is 0.3 to 0.8, more preferably 0.7.

The thickness of the nanoporous film can be controlled according to the wavelength of the light to be antireflected. In one embodiment of the present invention, if the polymethacrylate in the polystyrene-block-polymethylacylate block copolymer is selectively degraded and removed by exposing it to infrared wavelength, the thickness of thin film can vary proportionally within 120 to 200 nm so as to prevent the light reflection of 600 nm to 1,000 nm wavelength.

The antireflective film thickness can be adjusted during the coating step through the control of the concentration of the block copolymer and the coating method. In one embodiment of the present invention, the coating amount of the mixed solution is enough to cover well the desired size of substrate. For example, if the substrate is 2.5 cm²×2.5 cm², the desired thickness of the film can be obtained at the rotating speed of 3,000 to 8,000 rpm with a proper control of the concentration of the solution.

Any coating methods can be used to make the block copolymer solution rapidly and evenly evaporated and the thickness of the film controlled, and includes, but are not limited to, various coating methods such as a roll coating, a bar coating, a dip coating, a spin coating and the like.

In one aspect of the present invention, the present invention provides an antireflection thin film with a pore size of 5 to 100 nm and a pore volume fraction of 0.3 to 0.8, which is formed on the substrate having a refraction index of 1.45 to 1.80.

The thin film is formed from by the remaining components which are not removed from the block copolymer and, preferably, the remaining component is polystyrene. In one preferred embodiment, the polystyrene is cross-linked and forms an antireflective membrane during the process of removing a block copolymer component.

In one embodiment of the present invention, the thickness of the thin film can be controlled by a coating method or an amount of the coating and the thickness of 100 to 200 nm is preferred. In a preferred embodiment, the thickness of the polystyrene thin film can be varied according to the wavelength of incident light. For example, the light of 600 nm, 800 nm and 940 nm wavelength can optimize the reflectance through a thin film with a thickness of 125 nm, 170 nm and 200 nm, respectively.

Hereinafter, the present invention will be illustrated in detail by the following examples. The examples are presented for illustrating the present invention and should not be construed as limiting the scope of the present invention.

### EXAMPLES

Polystyrene-block-poly(methylmethacrylate) copolymer (PS-b-PMMA), purchased from Polymer Source Inc. (Lot No. P2406-SMMA), was synthesized by using anionic polymerization. The total number-average molecular weight (Mn), the polydispersity, and the weight fraction of the PMMA block in the block copolymer were 94,200, 1.15 and 0.72, respectively. To convert the weight fraction to the volume, the mass density was set to PS (1.05 g/cm³) and PMMA (1.18 g/cm³). Thus, the volume fraction of PMMA block (f_{PMMA}) in the block copolymer was 0.69. This block copolymer exhibited PS cylindrical microdomains when annealed at 170° C. for 48 hours.

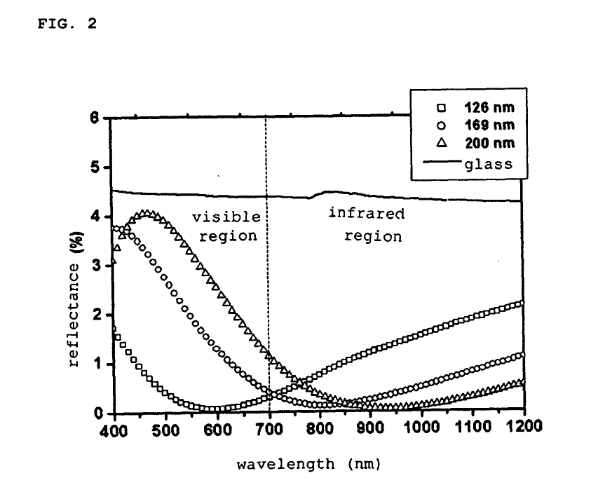

Glass slide, purchased from Corning Glass Works (Product #2947), which was soda lime glass which has the refractive index of 1.52, was spin-coated with PS-b-PMMA in toluene (2 to 3% by weight) with a rotating speed of 2,000 to 4,000 rpm. The coated film was irradiated with an ultraviolet lamp with a maximum intensity at 253 nm for 1 hour in a vacuum chamber, which degraded PMMA chains, but cross-links PS chains. After the UV irradiation, the film was dipped into acetic acid for 30 minutes followed by washing it with distilled water. Finally, the film was dried for 6 hours. The cross-sectional view of the film was investigated by a scanning electron microscope (SEM) and demonstrated the preparation of porous film (FIG. 2).

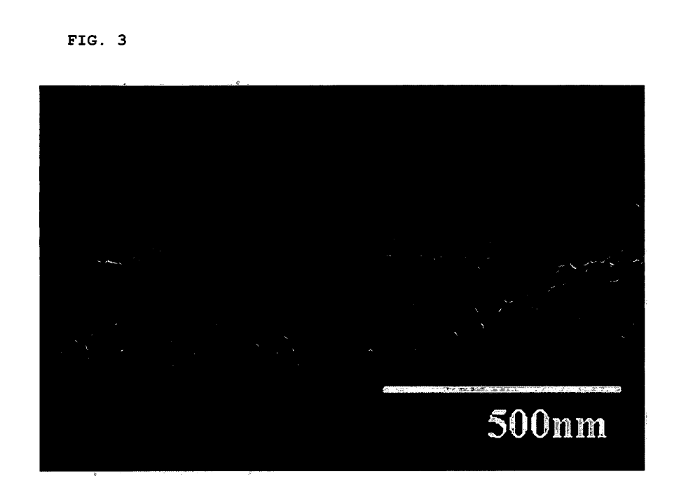

The porous PS-b-PMMA films with three thickness (12, 169 and 200 nm) were prepared and the reflectances for the three films were measured. The results are shown in FIG. 3.

The reflectance of the prepared porous films was measured, while changing the f_{PMMA} in PS-PMMA copolymer to 0.46 and 0.30. When the f_{PMMA} was 0.46, the reflectance of the PS-b-PMMA at 500 nm was 0.4%. When the f_{PMMA} was 0.30, the reflectance of the PS-b-PMMA at 500 nm was 1.4%.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of producing a porous thin film having an irregular mesh structure with a pore size of 5 to 100 nm, which comprises the steps of:
coating a block copolymer; and
selectively removing at least one block in the coated block copolymer,
wherein the removal of at least one block is carried out by an ozone treatment and/or a chemical treatment.

2. The method of claim 1, wherein the block copolymer is selected from the group consisting of a linear block copolymer and a graft block copolymer.

3. The method of claim 1, wherein the block copolymer is selected from the group consisting of acrylate-based block copolymer such as polystyrene-block-poly(methylmethacrylate), polyvinylpyridine-block-poly(methylmethacrylate) an the like, polystyrene-block-polyvinylpyridine, polystyrene-block-polyisoprene, polystyrene-block-polybutadiene and polystyrene-block-polyethylene oxide.

4. The method of claim 1, wherein the block copolymer is coated by a spin coating process, a bar coating process or a roll coating process.

5. A method of producing a nanoporous thin film for antireflection, which comprises the steps of:
coating a substrate with a block copolymer; and
selectively removing at least one block in the coated block copolymer,
wherein the removal of at least one block is carried out by an ozone treatment and/or a chemical treatment.

6. The method of claim 5, wherein the block copolymer is selected from the group consisting of a linear bock copolymer and a graft block copolymer.

7. The method of claim 6, wherein the block copolymer is selected from the group consisting of acrylate-based block copolymer such as polystyrene-block-poly(methylmethacrylate), polyvinylpyridine-block-poly(methylmethacrylate) an the like, polystyrene-block-polyvinylpyridine, polystyrene-block-polyisoprene, polystyrene-block-polybutadiene and polystyrene-block-polyethylene oxide.

8. The method of claim 5, wherein the step of coating the substrate with the block copolymer is followed by evaporating a solvent.

9. The method of claim 8, wherein the block copolymer is coated by a spin coating process, a bar coating process or a roll coating process.

10. The method of claim 5, wherein the volume fraction of the block removed from the block copolymer is 0.3 to 0.8.

11. The method of claim 5, wherein the refraction index of the substrate which is coated with the block copolymer is 1.45 to 1.80.

12. The method of claim 11, wherein the substrate is a glass, indium tin oxide or plastics.

13. The method of claim 5, wherein the pore size of the thin film is 5 to 100 nm.

14. The method of claim 5, wherein the antireflection thin film is used for optical reflection.
